(19) United States
(12) Patent Application Publication
(10) Pub. No.: US 2015/0168326 A1
(43) Pub. Date: Jun. 18, 2015

(54) METHOD AND DEVICE FOR TESTING SEMICONDUCTOR SUBTRATES FOR RADIOFREQUENCY APPLICATION

(71) Applicant: Soitec, Bemin (FR)

(72) Inventor: Frederic Allibert, Albany, NY (US)

(73) Assignee: SOITEC, Bernin (FR)

(21) Appl. No.: 14/372,192

(22) PCT Filed: Jan. 15, 2013
(86) PCT No.: PCT/IB2013/000044

§ 371 Date: Jul. 14, 2014

(30) Foreign Application Priority Data
Jan. 16, 2012 (FR) 1250396

(51) Int. Cl. G01N 27/04

(52) U.S. Cl. CPC G01N 27/041

(57) ABSTRACT

The invention relates to a method for testing a semiconductor substrate (1) for radiofrequency applications, characterized in that the electrical resistivity profile of the substrate as a function of depth, is measured and, using the profile, a criterion is calculated, defined by the formula (I): where D is the integration depth, σ(x) is the electrical conductivity measured at a depth x in the substrate, and L is a characteristic attenuation length of the electric field in the substrate. The invention also relates to a method for selecting a semiconductor substrate (1) for radiofrequency applications and to a device for implementing these methods.

### CROSS-REFERENCE TO RELATED APPLICATIONS

This application is a national phase entry under 35 U.S.C. §371 of International Patent Application PCT/IB2013/000044, filed Jan. 15, 2013, designating the United States of America and published in English as International Patent Publication WO 2013/108107 A1 on Jul. 25, 2013, which claims the benefit under Article 8 of the Patent Cooperation Treaty and under 35 U.S.C. §119(e) to French Patent Application Serial No. 1250396, filed Jan. 16, 2012, the disclosure of each of which is hereby incorporated herein in its entirety by this reference.

### TECHNICAL FIELD

The present invention relates to a method and device for testing a semiconductor substrate for radiofrequency applications, and to a method and device for selecting semiconductor substrates for such applications.

### BACKGROUND

Semiconductor substrates used to form radiofrequency (RF) devices must have a high electrical resistivity, i.e., typically higher than 500 ohm·cm, preferably higher than 1000 ohm·cm, even 3000 ohm·cm, in order to obtain RF devices that perform well.

It is more particularly important for the electrical resistivity to be high in the surface region of the substrate, i.e., on the surface of the side of the substrate in or on which the radiofrequency devices are formed.

Because at high frequencies electric fields penetrate into the substrate and affect any charge carriers that they encounter, substrates for radiofrequency devices are subject to, on the one hand, transmission loss or “insertion loss,” or, on the other hand, behavior-modifying crosstalk between devices through the substrate.

In addition, the rise and fall of the signal induces a variation in the capacitance of the substrate, which leads to the generation of waves at harmonic frequencies of the main frequency.

These harmonic waves and their combinations may generate parasitic signals that are particularly disadvantageous for radiofrequency applications.

To measure the radiofrequency performance of a device, it is, therefore, possible to measure the power of the harmonics generated—typically the second order to fifth order harmonics—as a function of the applied power.

Verifying that a substrate is suitable for radiofrequency applications is, therefore, a problem.

It is possible to test radiofrequency performance using test structures that are produced on the substrates that it is desired to test.

However, producing and then taking measurements using these test structures is a long and costly process.

Moreover, the results of the RF measurements may vary depending on the test structure employed.

Furthermore, the facilities needed to measure RF performance are expensive and substrate manufacturers normally do not have such facilities at their disposal.

Specifically, these facilities may comprise a cleanroom for producing the test structures, high-quality filters, linear (harmonic-free) power generators, vector analyzers and a measurement suite (room, measurement station, probes) designed not to distort the measured signal.

Substrate manufacturers are, therefore, not themselves able to test the qualification, with respect to RF performance, of the substrates that they supply.

It would, therefore, be desirable, instead of producing test structures and carrying out testing using these structures, to have a method allowing substrates intended for fabrication of RF devices to be tested directly.

Substrate manufacturers have at their disposal methods for measuring the electrical resistivity of substrates.

These methods comprise the four-point probe measurement method and the method known by the acronym “SRP” (spreading resistance profiling).

The four-point probe measurement method comprises passing a current through a semiconductor substrate between two electrodes, and in measuring, between two other electrodes, the voltage at the substrate terminals.

However, this method gives only an incomplete indication of the resistivity of the substrate because the electrodes are merely applied to the surface of the substrate and, therefore, only allow the average resistivity of the substrate to be measured.

However, the resistivity of the substrate generally varies significantly as a function of depth under the surface.

Moreover, for the most part, it is a surface layer of the substrate, having a thickness of about 10, 50 or 100 μm, that is of interest, because it is in this part of the substrate that the aforementioned effects occur.

The SRP method provides a more complete analysis because it allows the profile of the electrical resistivity to be defined for a semiconductor substrate as a function of depth in the substrate.

Specifically, the substrate is prepared by polishing, from one of its flat sides, a chamfer having an angle that allows the desired depth in the substrate to be reached.

Next, two electrodes are applied to the chamfered part of the substrate, the electrodes being spaced apart by a fixed distance, and forming a segment parallel to the edge of the chamfer, and a preset voltage is applied across the two electrodes.

The resistance between the two electrodes is measured, then the electrical resistivity of the substrate at the measurement depth is deduced from this measurement.

By carrying out this measurement at various distances from the edge of the chamfer (corresponding to various depths in the substrate), it is then possible to draw a resistivity profile curve that shows the resistivity as a function of depth in the substrate.

However, even though substrate manufacturers are able to guarantee that the substrates that they supply meet particular specifications in terms of electrical resistivity, these specifications are uncorrelated with the RF performance of the devices that will subsequently be fabricated on these substrates.

This is because there is no clear relationship between the electrical resistivity profile of a substrate and the RF performance of the devices formed on that substrate.

In particular, it has been observed that different electrical resistivity profiles can lead to similar RF performance.

One aim of the invention is, therefore, to provide a method for testing a semiconductor substrate for radiofrequency applications, which makes it possible to verify the adequacy of a substrate against the RF performance specifications of the devices that will subsequently be fabricated on the substrate.

Another aim of the invention is to provide a testing method and device that can be easily implemented by substrate manufacturers, and that are inexpensive so as not to unduly increase the cost of the substrate.

One aim of the invention is also to provide a method for selecting semiconductor substrates, making it possible to select, from among these substrates, those that will indeed enable devices having satisfactory RF performance to be fabricated thereon.

### DISCLOSURE

According to the invention, a method is provided for testing a semiconductor substrate for radiofrequency applications in which the electrical resistivity profile of the substrate as a function of depth is measured and, using that profile, a criterion is calculated, defined by the formula:

$$QF = {\int }_{0}^{D} σ ( x ) \cdot {e}^{\frac{- x}{L}} d x$$

where D is the integration depth, σ(x) is the electrical conductivity measured at a depth x in the substrate, and L is a characteristic attenuation length of the electric field in the substrate.

In a particularly advantageous way, the resistivity profile is measured using the “spreading resistance profiling” (SRP) method.

The SRP method comprises steps consisting in, on a substrate having a bevel polished from its top surface: measuring the resistance between two electrodes applied at a given distance from the edge of the bevel, drawing a resistance curve using the measurements carried out at various distances, and applying a deconvolution to the curve so as to deduce therefrom the electrical resistivity profile of the substrate.

The criterion QF represents the likelihood of radiofrequency devices fabricated on a substrate providing a satisfactory RF performance.

More precisely, the lower this criterion is, the better the RF performance of devices fabricated on the substrate.

Preferably, the integration depth D is greater than or equal to the characteristic attenuation length L.

In a particularly advantageous way, the characteristic attenuation length L of the electric field is chosen depending on the size of the devices intended to be produced on the semiconductor substrate.

Another subject of the invention relates to a method for selecting semiconductor substrates for radiofrequency applications, in which the testing method defined above is used to test the substrates, and one or more substrates for which the calculated criterion is lower than a given limit are selected.

According to one embodiment, to define the limit, an integration depth D and a characteristic attenuation length L of the electric field are chosen, and a maximum value for the power of at least one harmonic order generated is chosen.

Another object of the invention is a device for testing semiconductor substrates for radiofrequency applications, which comprises a device for measuring the resistivity profile of a substrate and a processing unit able to calculate, using the resistivity profile measured by the measuring device, a criterion given by the formula:

$$QF = {\int }_{0}^{D} σ ( x ) \cdot {e}^{\frac{- x}{L}} d x$$

where D is the integration depth, σ(x) is the electrical conductivity measured for the substrate at a depth x, and L is a characteristic attenuation length of the electric field in the substrate.

Preferably, the measuring device is a measuring device that employs the “spreading resistance profiling” (SRP) method.

Another object of the invention is a device for selecting semiconductor substrates for radiofrequency applications comprising the testing device described above in which the processing unit is able to compare the calculated criterion with a predefined limit.

In a particularly advantageous way, the processing unit is furthermore able to calculate, using a value of the criterion, at least one theoretical resistivity profile corresponding to this criterion.

### BRIEF DESCRIPTION OF THE DRAWINGS

Other features and advantages of the invention will become clear from the following detailed description, given with reference to the appended drawings, in which:

FIG. 1A is a conceptual schematic illustrating implementation of the SRP method;

FIG. 1B is a conceptual schematic illustrating implementation of the SSRM method;

FIG. 2 is a graph showing, by way of example, the resistivity profiles of various substrates as a function of depth in the substrate;

FIG. 3 is a graph showing, by way of example, the power profile of second order harmonics for various substrates as a function of the power of the input signal;

FIG. 4 is a graph showing correlations between the value of the criterion SRP_{QF} for various substrates and the power of the second order harmonics; and

FIG. 5 is a graph presenting various possible resistivity windows as a function of depth in the substrate.

### DETAILED DESCRIPTION

The resistivity profile of the substrate may be determined using any appropriate method.

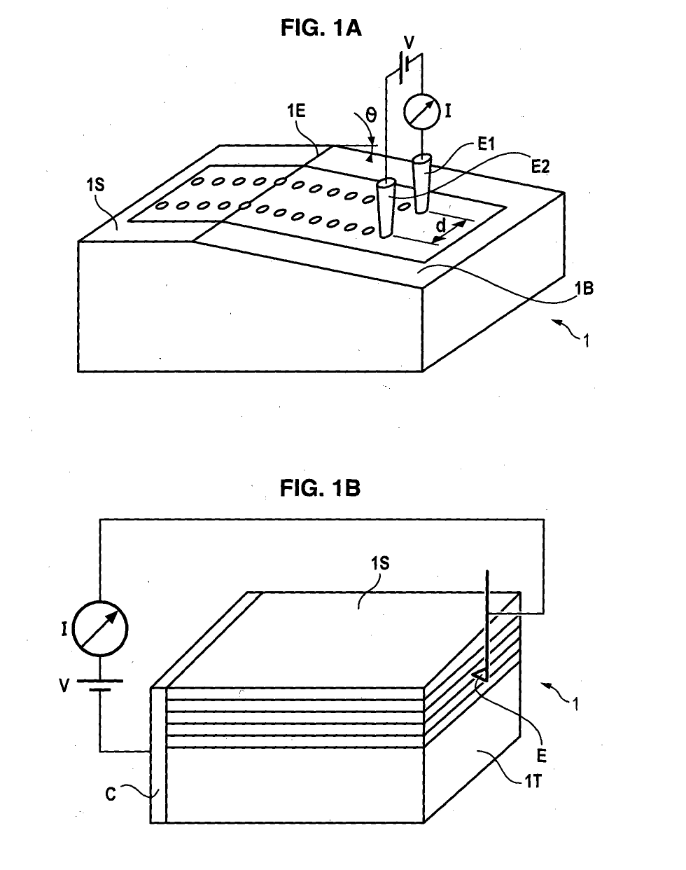

Preferably, the spreading resistance profiling (SRP) method is used, the implementation of which is illustrated in FIG. 1A.

With reference to FIG. 1A, the SRP method is implemented on a semiconductor substrate 1 that has already been polished, from its flat top side 1S (on which the radiofrequency devices are intended to be formed), so as to produce a chamfer 1B extending from an edge stop 1E on the side 1S, the chamfer 1B having an angle θ that allows the desired depth in the substrate 1 to be reached.

The substrate may be made of any semiconductor material suitable for radiofrequency applications.

Among preferred materials, mention may be made of high-resistivity (HR) silicon (i.e., having an electrical resistivity higher than 500 ohm·cm, preferably higher than 1000 ohm·cm, and even higher than 3000 ohm·cm).

The substrate may optionally be a semiconductor-on-insulator (SeOI) substrate, and preferably a silicon-on-insulator (SOI) substrate, which is to say a structure comprising a carrier substrate, a buried dielectric layer (generally called a BOX for “Buried OXide layer”) and a thin layer of a semiconductor in or on which the radiofrequency devices are fabricated.

For a radiofrequency device, an important effect is the penetration of the electric field into the substrate, the electric field being gradually attenuated with distance into the substrate.

To determine the suitability of the substrate for radiofrequency applications, it is essentially the resistivity of a surface layer of the substrate located under the top surface of the substrate that is of interest.

In the context of the test covered by the present invention, it is typically sought to measure the resistivity profile to a depth of about 5 to 50 μM under the top side of the substrate.

When the substrate is an SeOI substrate, it is sought to measure the resistivity profile in the carrier substrate, i.e., under the buried dielectric layer.

That being so, it is not absolutely necessary to remove the dielectric layer.

The brochure published by Solecon Laboratories Inc., entitled “Determination of Diffusion Characteristics Using Two- and Four-Point Probe Measurements” and authored by R. Brennan and D. Dickey, describes a standard way of implementing the SRP method.

The ends of two electrodes E1, E2, which are spaced apart by a fixed distance d and which form a segment parallel to the edge of the chamfer 1E, are applied to the chamfered part 1B of the substrate 1, and a preset voltage V is applied across the two electrodes.

The operating conditions are given in the aforementioned brochure.

In particular, the distance d is typically about 1 to 20 μm and the voltage V applied across the electrodes E1 and E2 is about a few mV, for example, 5 mV.

The resistance between the two electrodes E1 and E2 is measured.

Each measurement is stored in a processing unit, for example, a computer.

By carrying out this measurement at various distances from the edge of the chamfer (corresponding to various depths in the substrate), it is then possible to draw a curve of the resistance as a function of depth in the substrate.

Next, by virtue of the processing unit, a deconvolution algorithm is applied to the curve in order to obtain the complete resistivity profile, which profile represents the resistivity as a function of depth in the substrate.

Alternatively, the resistivity profile of the substrate may be measured by means of the scanning spreading resistance microscopy (SSRM) method, which is a variant of the SRP method described below, whereby the substrate 1 is cleaved perpendicularly to its flat top side 1S, a contact C is formed on a side perpendicular to the side 1S, and a conductive electrode E is moved along the thickness of the substrate over the side 1T opposite the side bearing the contact C (see FIG. 1B).

An appropriate device is, for example, sold by Park Systems™.

According to other non-limiting embodiments included in the scope of the present invention, the resistivity profile of the substrate may also be obtained by carrying out successive steps of grinding the top surface of the substrate and measuring, for each depth defined in this way, the resistance of the substrate; or alternatively, by producing contacts at various depths in the substrate, via which contacts the resistance of the substrate is measured.

In the remainder of this description, a resistivity profile obtained by the SRP method is generally considered but it goes without saying that the profile may be obtained by any other suitable method, and especially by one of the methods envisioned above.

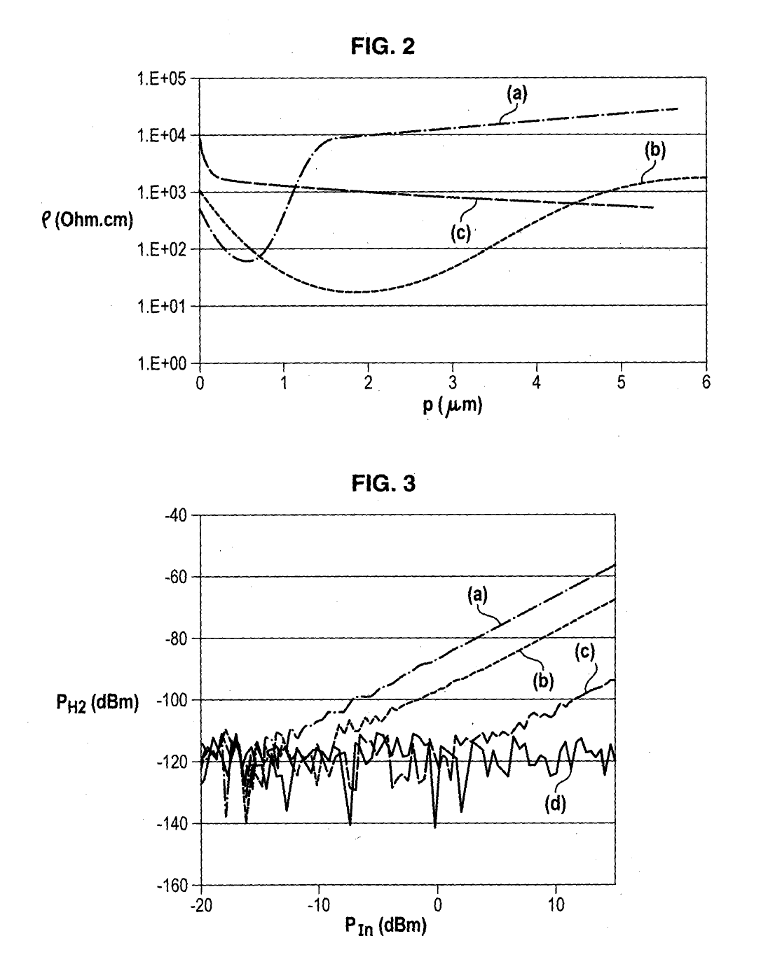

FIG. 2 shows, by way of example, various resistivity ρ profiles as a function of depth p, measured on various substrates by the SRP method.

The curve (a) is for a substrate with a very high resistivity but having a shallow low-resistivity surface zone.

The profile (c) corresponds to a substrate with a poorer resistivity, but without a low-resistivity surface zone.

The substrate corresponding to the curve (c) has a lower QF criterion (defined below) than the substrate corresponding to curve (a) and therefore offers a better RF performance.

The substrate (b) contains a large low-resistivity zone.

Its QF criterion is high and its RF performance mediocre.

To measure the RF performance of a substrate, coplanar metal lines are deposited on the top side of the substrate, one central line being surrounded by two parallel grounded lines.

For a signal of given power and given fundamental frequency injected into the central line, the attenuation of the power for the fundamental frequency, on the one hand, and the power received for various harmonic frequencies, on the other, are measured.

FIG. 3 illustrates, by way of indication, various power profiles for second order harmonics (P_{H2}, expressed in dBm) as a function of the power of the input signal (Pₗₙ, expressed in dBm).

The profiles (a) and (b) correspond to two HR silicon substrates of different resistivities, and comprising no “trap rich” layer intended to trap carriers.

Curve (c) corresponds to an HR-SOI substrate comprising a trap rich layer.

Lastly, curve (d) corresponds to an insulating reference substrate made of glass.

The Applicant has determined a criterion based on the measurement of the resistivity profile of a substrate, which provides a good indication with regard to the performance of radiofrequency devices subsequently fabricated on this substrate.

The criterion, here denoted QF (standing for “quality factor”) is defined by the formula:

$$QF = {\int }_{0}^{D} σ ( x ) \cdot {e}^{\frac{- x}{L}} d x$$

where D is the integration depth, σ(x) is the electrical conductivity measured at a depth x in the substrate, and L is a characteristic attenuation length of the electric field.

The local electrical conductivity σ(x) is obtained by inverting the resistivity profile of the substrate, measured by the SRP method described above.

The length L is related to the penetration depth of the electric field into the substrate, which is related to the size of the devices for which it is desired to predict the performance.

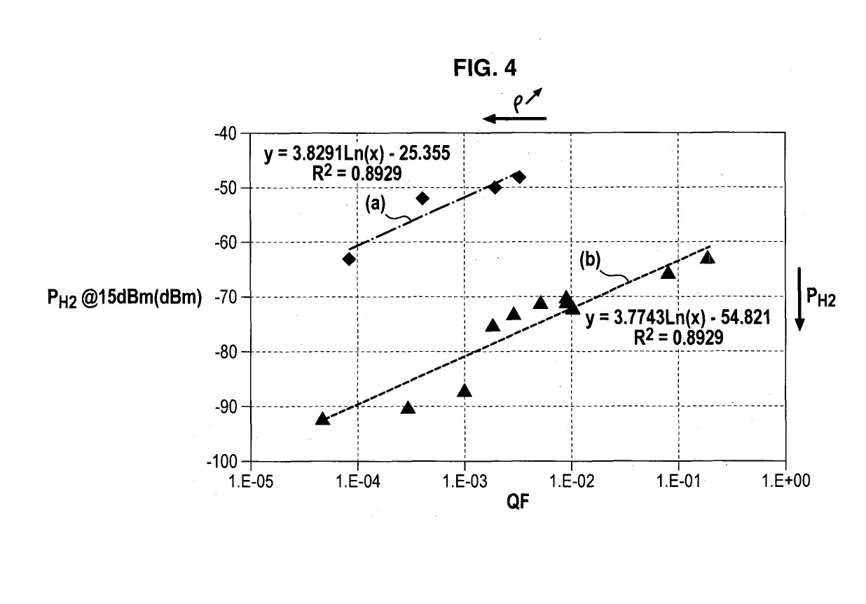

In the case of the correlation shown in FIG. 4, the length L has been chosen depending on the spacing between the coplanar lines used to measure the attenuation of the signal at the fundamental frequency and the power of the various harmonics.

Specifically, the larger the distance between the coplanar lines, the greater the penetration depth of the electric field into the substrate.

The length L depends on the size of the devices formed on the substrate.

Therefore, depending on the size of the devices intended to be fabricated on the substrate, a different value will possibly be chosen for the length L.

It will thus be possible to define various criteria SRP_{QF} depending on the various devices to be fabricated on the substrate.

Generally, the length L may be chosen to be half the distance between two coplanar lines.

The integration depth D is chosen to be as large as possible, while being limited by the maximum depth of the measurement carried out using the SRP method.

Preferably, a depth D that is much greater than the characteristic length L is chosen, the depth D having to be increased in proportion to the penetration depth of the electric field into the substrate.

In any case, it is important to choose integration depths that are substantially identical for all the samples, or to normalize the result, in order to be able to compare various resistivity profiles.

FIG. 4 shows correlations obtained between the QF criterion defined above and the power of the second order harmonics P_{H2} (expressed in dBm) measured for an input power Pₗₙ of 15 dBm.

The arrow located above the graph and pointing from right to left shows the direction of the increase in the resistivity ρ of the substrate.

The arrow located to the right of the graph and pointing from top to bottom shows the direction of the decrease in the power of the harmonics.

The points (squares) of the straight line (a) were obtained using measurements carried out on silicon substrates, commonly used to form HR-SOI substrates, having a high resistivity but not having a carrier trapping layer.

The points (triangles) of the straight line (b) were obtained using measurements carried out on “trap rich” silicon substrates having a high electrical resistivity and a layer intended to trap carriers and prevent variations in potential under the buried dielectric layer.

As the straight lines (a) and (b) show, a rather good correlation is obtained between the QF criterion, on the one hand, and the power of the second order harmonics (which is an RF performance criterion) on the other.

It may also be seen that, for a given value of the QF criterion, a significant reduction (about −30 dBm) in the power of the second order harmonics is obtained with a trap rich substrate, relative to a standard HR-SOI substrate.

Using charts such as that illustrated in FIG. 4, it is, therefore, possible to determine, for a desired maximum value of the power of the second order harmonics, a maximum value of the QF criterion to be respected, depending on the type of substrate used.

Moreover, it is possible to calibrate these charts for various RF device sizes of interest.

Thus, a set of characteristic lengths L will possibly be defined.

Advantageously, the integration depth D will be chosen to be greater than the greatest length L selected.

The criterion QF is, therefore, a substrate quality criterion that may be easily verified by a substrate manufacturer.

Specifically, this test requires only the implementation of a method for measuring the resistivity profile, for example, the SRP method, which is already implemented by substrate manufacturers and, therefore, does not require additional investment, and the integration of the conductivity profile using the values defined above for L and D.

This test may advantageously be implemented by means of a processing unit comprising a processor capable of implementing an algorithm for calculating the QF criterion from a resistivity profile, obtained, for example, by the SRP method, and the input data L and D.

Advantageously, this test may be implemented with a view to selecting one or more substrates that are suitable for producing particular radiofrequency devices.

Specifically, based on the structure of the devices in question, L and D values appropriate for the calculation of the QF criterion are defined as indicated above.

Moreover, based on the specifications of the manufacturer for the devices in terms of the RF performance to be achieved, a target value is defined for a quantity representative of this performance.

For example, this representative quantity may be the power of the second order harmonics for an input signal power of 15 dBm.

Purely by way of illustration, the target value for this quantity may be chosen to be −80 dBm, which corresponds to the acceptable maximum power.

Using this target value, it is possible to define a maximum value for the QF criterion, a substrate having a lower QF criterion being considered to meet the required specifications in terms of RF performance.

By calculating for various substrates the resistivity profile of which is known, for example, by virtue of an SRP measurement, the QF criterion with the appropriate L and D values determined beforehand, it is, therefore, possible, with ease, to identify substrates that are suitable for the radiofrequency devices to be fabricated.

Conversely, based on a defined value of the QF criterion, it is possible, by virtue of a computational algorithm implemented by the processing unit, to determine various theoretical resistivity profiles that correspond to this criterion and that, therefore, meet the specifications in terms of RF performance.

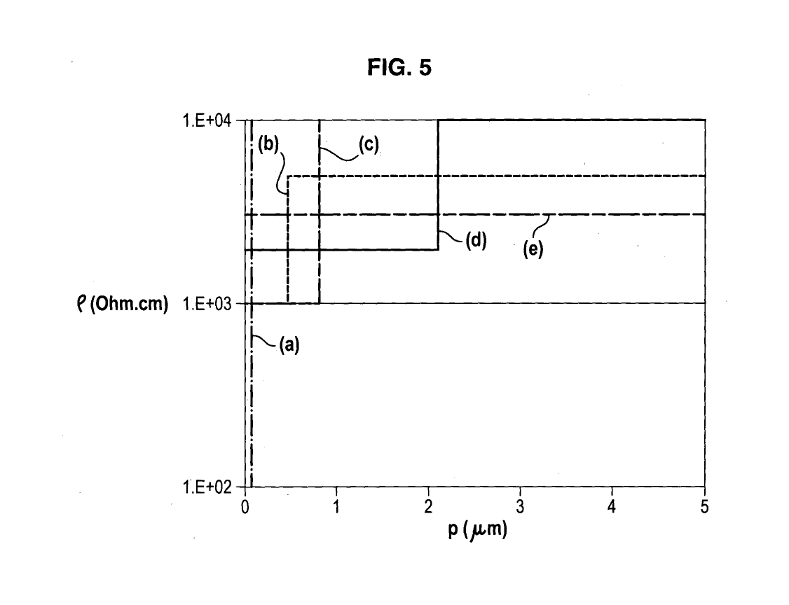

By way of example, FIG. 5 shows various resistivity profiles, (a) to (e), which all result in second order harmonics with a power of −80 dBm for an input signal power of 15 dBm.

Depending on the type of substrate selected and on the constraints associated with the manufacturing process of the substrate, the substrate manufacturer is able to define, in order to respect one of these profiles, a minimum base resistivity, a thermal budget leading to the diffusion of dopant elements liable to contaminate the substrate during its manufacture, and, therefore, a maximum acceptable dopant concentration, etc.

The manufacturer is, therefore, better able to define the manufacturing process window.

It goes without saying that the invention is not limited to the examples described above.

In particular, while it was the power of the second order harmonics that was described here for the purpose of the correlations with the calculated QF criterion, in a similar way, the power of higher order harmonics could be chosen for these correlations, or the input signal power level selected for the comparison could be varied, or the output signal of the fundamental frequency could be chosen, etc.

1. A method for testing a semiconductor substrate for radiofrequency applications, comprising:
measuring an electrical resistivity profile of the substrate as a function of depth; and
using the electrical resistivity profile, calculating a Quality Factor (QF) criterion, defined by the formula:
$$QF = {\int }_{0}^{D} σ ( x ) \cdot {e}^{\frac{- x}{L}} d x$$
where D is an integration depth, σ(x) is an electrical conductivity measured at a depth x in the substrate, and L is a characteristic attenuation length of the electric field in the substrate.

2. The method of claim 1, wherein the integration depth (D) is greater than or equal to the characteristic attenuation length (L).

3. The method of claim 1, wherein the characteristic attenuation length (L) of the electric field is chosen depending on the size of the devices intended to be produced on the semiconductor substrate.

4. The method of claim 1, wherein the resistivity profile is measured by means of the spreading resistance profile (SRP) method.

5. The method of claim 1, further comprising testing a plurality of semiconductor substrates using the method of claim 1, and selecting one or more of the tested semiconductor substrates for which the calculated criterion (QF) is lower than a given limit, and fabricating semiconductor devices using the selected semiconductor substrates.

6. The method of claim 5, further comprising, defining the given limit by choosing an integration depth (D), and a characteristic attenuation length (L) of the electric field, and a maximum value for the power of at least one harmonic order generated.

7. A device for testing semiconductor substrates for radiofrequency applications, comprising:
a measuring device configured to measure the resistivity profile of a substrate; and
a processing unit configured to calculate, using the resistivity profile measured by the measuring device, a Quality Factor (QF) criterion given by the formula:
$$QF = {\int }_{0}^{D} σ ( x ) \cdot {e}^{\frac{- x}{L}} d x$$
where D is an integration depth, σ(x) is an electrical conductivity of the substrate measured at a depth x, and L is a characteristic attenuation length of the electric field in the substrate.

8. The device of claim 7, wherein the measuring device is a measuring device that employs the spreading resistance profiling (SRP) method.

9. A device for selecting semiconductor substrates for radiofrequency applications, comprising a testing device as recited in claim 7, and wherein the processing unit is configured to compare the calculated Quality Factor (QF) criterion with a predefined limit.

10. The device of claim 9, wherein the processing unit is further configured to calculate, using a value of the Quality Factor (QF) criterion, at least one theoretical resistivity profile corresponding to the Quality Factor (QF) criterion.

11. The method of claim 2, wherein the characteristic attenuation length (L) of the electric field is chosen depending on the size of the devices intended to be produced on the semiconductor substrate.

12. The method of claim 2, wherein the resistivity profile is measured by means of the spreading resistance profile (SRP) method.

13. The method of claim 3, wherein the resistivity profile is measured by means of the spreading resistance profile (SRP) method.
